(19) United States
(12) Patent Application Publication
(10) Pub. No.: US 2016/0319164 A1
(43) Pub. Date: Nov. 3, 2016

(54) BREATHABLE POLYPROPYLENE BASED PRESSURE SENSITIVE ADHESIVE COATED SHEET FOR BLOOD BAG APPLICATION

(71) Applicant: Avery Dennison Corporation, Glendale, CA (US)

(72) Inventor: Sudarshana MUKHERJEE, Pune (IN)

(21) Appl. No.: 15/141,999

(22) Filed: Apr. 29, 2016

(30) Foreign Application Priority Data
Apr. 30, 2015 (US) 1727/MUM/2015

(51) Int. Cl. C09J 7/02; C09J 133/00; G09F 3/10; A61J 1/14; A61J 1/18; G09F 3/02; C08J 5/18; A61J 1/10

(52) U.S. Cl. CPC C09J 7/0289; C08J 5/18; C09J 133/00; A61J 1/10; A61J 1/1468; A61J 1/18; G09F 3/02; G09F 3/10; C09J 2423/006; C09J 2433/00; C08J 2323/12; G09F 2003/0272

(57) ABSTRACT

Various labels and labeling techniques for application to blood bags are described. The labels include one or more microporous polypropylene films and adhesive. Also described are blood bags having the labels adhered thereto and related methods of use.

### CROSS REFERENCES TO RELATED APPLICATION

The present application claims the benefit of Indian Provisional Application No. 1727/MUM/2015 filed on Apr. 30, 2015, which is incorporated herein by reference in its entirety.

### FIELD

The present subject matter relates to polypropylene based sheets or films. More particularly, the present subject matter relates to breathable polypropylene based microporous sheeting/face material with pressure sensitive adhesive coating for use in pressure sensitive constructions, and particularly in blood bag label applications. The present subject matter also relates to labeled blood bags using the present subject matter technology.

### BACKGROUND

Blood transfusion is an ever growing medical need amongst patients of various ailments and disease conditions. In this regard blood bags are used to store and contain blood for use in various processes, and assist in infusing the blood to a recipient. Blood bags are required to have robust labels to reliably track blood from a donor to a final recipient. Various types of polymeric sheeting, including single layer or multilayer, are typically used with adhesive coatings for blood bag label applications. Before the transfusion takes place, the bag and the attached label are subjected to many processing, testing, and storage operations which are often very challenging for labels, and particularly for adherence to quality and regulatory norms. For example, labeled blood bags are subjected to high temperatures for sterilization purposes. Such exposure to high temperature causes the polymeric sheeting to deform, degrade or shrink, particularly at the sheeting and adhesive interface. Moreover, the label should withstand centrifugation, cryogenic freezing, shaking or warming in water baths. Currently for blood bag label applications, the most known and sought after labelling technique is to use Teslin based face material which is essentially microporous HDPE which is provided with solvent based adhesive. However, a major shortcoming with Teslin is that it is high in cost and thus its adoption is considerably limited. Conventional biaxially oriented polypropylene (BOPP) or cast polypropylene (PP) sheet/film typically exhibit wrinkles/piping during the blood bag processing steps. It has typically been known in the art that adhesive coated polypropylene films when exposed to elevated temperatures, shrink and show wrinkles/deformation/piping. When applied to a pliable surface such as a PVC blood bag, the difference in the shrinkage of a polypropylene label and the pliable PVC blood bag surface at elevated temperature worsens the situation. Furthermore, many other materials currently being used in blood bag label applications have now been indicated as hazardous or not eco-friendly.

Therefore, there is pressing need to develop a cost competitive technology which would provide a solution to the challenging label processing and handling steps and maintain the required quality and compliance norms while concurrently being environmentally friendly.

### SUMMARY

The difficulties and drawbacks associated with previous approaches are addressed in the present subject matter as follows.

In one aspect, the present subject matter provides a label adapted for use on blood bags. The label comprises a microporous polypropylene film defining a first face and an oppositely directed second face. The label also comprises adhesive disposed on at least one of the first face and the second face of the film.

In another aspect, the present subject matter provides a labelled blood bag comprising a blood bag defining an outer surface and a label adhered to the outer surface of the blood bag. The label includes a microporous polypropylene film that defines inner and outer faces, and adhesive disposed between the inner face of the film and the outer surface of the blood bag.

In yet another aspect, the present subject matter provides a polypropylene film having characteristics such that upon exposure to a temperature of 121° C. for 30 minutes, the label exhibits shrinkage characteristics that closely match shrinkage characteristics of a blood bag having a wall material of polyvinyl chloride.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic cross sectional illustration of a microporous polypropylene film having a layer or region of adhesive, in accordance with an embodiment of the present subject matter.

FIG. 2 is a schematic cross sectional illustration of a labeled blood bag in accordance with an embodiment of the present subject matter.

FIG. 3 is a photograph showing an embodiment of a microporous polypropylene filmic label on a blood bag before sterilization.

FIG. 4 is a photograph showing the polypropylene filmic label on the blood bag of FIG. 3 after sterilization.

### DETAILED DESCRIPTION OF THE EMBODIMENTS

One of the objects of the use as a present subject matter is to provide a microporous sheeting/film having qualities for face material in a pressure sensitive construction, and particularly for use in blood bag labelling.

Another object of the present subject matter is to provide the microporous sheeting/film in the form of microporous polypropylene or equivalent.

Yet another object of the present subject matter is to provide a method of preparation of the microporous sheeting/film.

Another object of the present subject matter is to provide a method of preparation of the microporous sheeting/film which can be performed by stretching polypropylene (PP) films so as to create interlamellar voids.

Another object of the present subject matter is to develop a pressure sensitive construction which is cost effective.

Another object of the present subject matter is to develop a pressure sensitive construction which has matching shrinkage to a substrate bag.

Yet another object of the present subject matter is to develop a pharmaceutical and regulatory compliant pressure sensitive construction for blood bag labelling.

A further object of the present subject matter is to develop a pressure sensitive construction for a blood bag label which meets various sustainability goals.

The embodiments and illustration of various aspects of the present subject matter are detailed herein. Various embodiments and features or advantageous details are explained with reference to nonlimiting embodiments that are illustrated or will be illustrated in the description. Description of well known components and processing techniques are omitted so as to not unnecessarily obscure the embodiments herein. The examples used herein are intended merely to facilitate an understanding of ways in which the embodiments herein may be practiced. The description or parts thereof should not be construed as limiting the scope of the embodiments herein.

The term “blood bag” as used herein refers to any container such as a flexible wall bag, pouch, or enclosure typically used in the medical arts to store and/or transport whole blood and/or blood components. Although the subject matter is described in conjunction with labeling blood bags, it will be understood that the subject matter is applicable to other containers or the like used in the medical field. Furthermore, as will be appreciated from the description of other embodiments herein, the subject matter is applicable to a wide array of other applications outside of the medical field.

In one embodiment of the subject matter, a cost competitive blood bag label is provided which will have minimal qualitative deviation. The face film or sheeting of the blood bag label is so designed that the label withstands the challenging conditions of high temperature, centrifugation, cryogenic freezing, change in temperature exposure, and flexibility for container-fill application with adhesion to a pliable polyvinyl chloride (PVC) bag surface.

Efforts were made to balance properties of the film/sheeting material such as 1) porosity, which can be found in face material of paper or Teslin; 2) cross direction shrinkage in coordination with a pliable underlying bag surface to withstand high temperature; and 3) pliability to accommodate freezing, centrifugation and container fill application so as to enable designing a pressure sensitive construction for blood bag application according to various embodiments herein.

In one embodiment the film/sheeting face material can be a microporous polypropylene or equivalent.

In order to produce a microporous polypropylene film or sheet, known industry methods can be used to produce microporosity such as by stretching a polyolefin film and more particularly a polypropylene film, to create interlamellar voids by pulling of the polyolefin film at the interface of solid inclusion. This concept of “pore” does not extend to the free volume or molecular level spaces. In terms of pore size, the microporous films of the present subject matter have interconnected pores typically having a size or span within a range of from 0.01 to 1 micron. The interconnectivity of the pores is achieved due to the creation of voids at the interlamellar spacing of pure semi-crystalline polyolefin, e.g., polypropylene, and an inhomogeneous interface between the polyolefin and solid filler or another incompatible polymer during their extension. Such pore formation may result from various factors, such as separation of phases in incompatible polymer blends or separation of inorganic polymer filler from the polymer matrix due to stress concentration. Additional details of pores, their formation, and characteristics are described in “Transport of Moist Air Through Microporous Polyolefin Films,” J. of Macromolecular Science, Vol. C 43, No. 2, p. 143-186 (2003).

Cavitated or microporous films are typically manufactured by incorporating incompatible cavitating agent particles in the polymer and stretching extruded sheets uniaxially or biaxially. Known cavitating agents include calcium carbonate (CaCO3) or Silica (SiO2) and PP-incompatible, higher-melting polymers such as polybutylene terephthalate (PBT) or nylon. These agents however add to the cost of the film and are difficult to disperse uniformly. Another alternative is to make film with high β crystallinity (K>0.8, fraction of β in the overall crystalline phase) and stretch it below the melting point of the β phase. Microvoids will form spontaneously as the β crystallites are converted to α. By the time the process is completed, most of the β phase will disappear. The method to raise the κ value is to use special nucleating agents such as Quinacridone dye, an aluminum salt of 6-quinazirin sulfonic acid, disodium salt of o-phthalic acid, isophthalic and terephthalic acids, N-N′-dicyclohexyl 2-6-naphthalene dicarboximide, blend of organic dibasic acid+oxide, hydroxide, and/or one or more acids of Group II metals (Mg, Ca, St, Ba.) which are finely dispersed into the polymer at low concentrations to seed crystals during solidification from the melt.

Additional details concerning a microporous polypropylene film in which film formability is improved with a β-crystal technique thereby allowing microporous films to be continuously manufactured at low cost, are described in CA 2772028.

Stretching can be performed to create voids of porosity values in a range of from about 2500 to 4771 Gurley seconds according to certain embodiments herein. A Gurley second is a unit describing the number of seconds required for 100 cubic centimeters (1 deciliter) of air to pass through 1.0 square inch of a given material at a pressure differential of 4.88 inches of water (0.176 psi), ISO 5636-5:2003. Thus, the term “microporous” as used in reference to the various films described herein, refers to films that exhibit porosity in a range of from 2,500 to 4,771 Gurley seconds. However, it will be understood that the present subject matter includes polypropylene films exhibiting porosity outside of this noted range such as less than 2,500 Gurley seconds or greater than 4,771 Gurley seconds.

It has been found that the noted porosity enables adhesion in addition to providing gas permeability and as a result, polypropylene can withstand a temperature of 121° C., while utilizing a particular thickness of the film with a density in the range of from 0.5 to 0.6 g/cc which promotes conformability. In many embodiments, the film has a thickness in a range of from about 100 microns to about 200 microns and more particularly 110 to 200 microns. However, it will be appreciated that the present subject matter includes films having thicknesses less than or greater than these representative values.

In certain embodiments, the microporous polypropylene film/sheet may not have any silica or other fillers as in Teslin. In these embodiments, the films are referred to as “silica-free.”

The microporous polypropylene film/sheeting can also exhibit characteristics that match shrinkage of a PVC bag which can be less than 2% in a machine direction during sterilization and 4-6% in a cross direction at 121° C. for 30 minutes. Thus, in these embodiments, shrinkage characteristics of the label film match or closely correspond to the shrinkage characteristics of the material used for a blood bag, which as noted is typically PVC.

In one embodiment, the microporous polypropylene film/sheeting face may have a thickness in the range from about 110-200 microns with a density in the range of from 0.5 to 0.6 g/cc. It has been found that a film thickness less than 110 microns with the noted polypropylene density will exhibit difficulty in dispensing and die cutting in a pressure sensitive construction due to poor stiffness. Therefore, the noted combination of thickness and density ranges balances both conformability needed during blood bag processing for container fill applications as well as to ensure good die cutting and matrix stripping.

In another embodiment of the present subject matter, a pressure sensitive construction such as labels for blood bag application is provided. The pressure sensitive construction can include a microporous film/sheeting as face material, and an adhesive layer underlying the microporous film/sheeting.

The pressure sensitive construction can be a single layer or a multi-layer construction.

In certain embodiments the pressure sensitive construction for blood bag labeling can further include a release layer or liner underlying the adhesive layer. As will be appreciated, the release layer at least partially covers the adhesive and is removed prior to label application.

In many embodiments, the adhesive in the adhesive layer is a solvent based permanent acrylic pressure sensitive adhesive with service temperature within a range of from −80° C. to 140° C. For many pharmaceutical applications the adhesive should meet FDA indirect food contact application requirements or any other compliance provision(s) under the applicable laws.

The substrate for the pressure sensitive construction can be a blood bag which is often made of PVC and is applied through the adhesive layer.

It has also been established under the present subject matter that since the substrate PVC of many blood bags shrinks less than 2% in a machine direction of the label during sterilization (121° C. for 30 minutes) and 4-6% in a cross direction of the label, in order to withstand the shrinkage of the underlying PVC bag, the label should shrink similarly thus avoiding any greater shrinkage of the film to the bag which can then lead to adhesive ooze after sterilization. Therefore, in certain embodiments, the film is stretched to achieve shrinkage of less than 2% in the machine direction at 121° C. and less than 4-6% in cross direction.

In many embodiments, the shrinkage characteristics of the film (upon heating to 121° C. for 30 minutes) closely match the shrinkage characteristics of the blood bag wall material, which is typically PVC. The term “closely match” as used herein refers to a dimensional difference after heating of the label that is within 90%, more particularly within 95%, and in certain embodiments within 99% of the corresponding dimension of the blood bag wall material.

In many embodiments, a significant feature of the present subject matter is to exhibit sufficient gas permeability to transmit air, vapour and gases. This provides a cushioning effect, conformability, better anchorage to the adhesive to withstand challenging conditions such as steam sterilization, centrifugation, adhesion to a pliable PVC bag surface and removal of any entrapped air bubbles between the label and the PVC bag.

An illustration of the requirement for permeability is from evidence that a paper or microporous HDPE (Teslin) film shows no label distortion or delamination after sterilization. However, a concern with the use of paper is low water resistance. Additional concerns related to the use of paper and microporous HDPE film (Teslin) are that such materials are not sustaining the cost needs of the blood bag market and therefore exhibit low market penetration.

Microporous polypropylene film shows flexibility for container-fill applications, and adhesion to a pliable PVC bag surface and thus meets the centrifugation process needs. In contrast, cast or oriented polypropylene film or synthetic polyolefins exhibit wrinkles or bubbles.

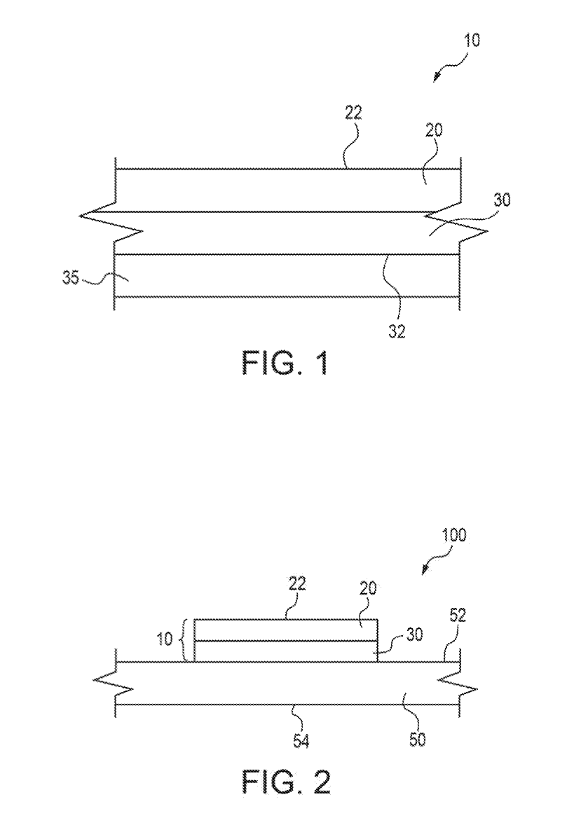

FIG. 1 is a schematic illustration of a label in accordance with an embodiment of the present subject matter. The label 10 comprises microporous polypropylene film 20 and at least one layer or region of an adhesive 30. The polypropylene film defines an outer face 22 which can receive indicia, markings, and/or other label components. The adhesive layer 30 defines an adhesive face 32 for adhering the polypropylene film 20 to a substrate (not shown) such as a blood bag. The label 10 may optionally comprise a liner 35 or release layer which is removed prior to application.

FIG. 2 schematically illustrates a labelled blood bag 100 in accordance with an embodiment of the present subject matter. The labelled blood bag 100 comprises a label 10 for example as depicted in FIG. 1 which is adhered to an outer face 52 of a blood bag wall 50. The label 10 is adhered to the bag via the adhesive layer 30. The bag wall defines an oppositely directed inner face 54.

### Substrate or Face Layer

As noted, the label assemblies of the present subject matter include a microporous substrate, facestock film or layer to provide support for the label. The facestock layer can be formed from a wide array of microporous materials, so long as the microporous filmic material exhibits sufficient gas permeability and the shrink characteristics of the filmic material closely match the shrink characteristics of the bag or substrate to which the label is adhered. Representative microporous materials for the facestock include, but are not limited to, polyethylene terephthalate (PET), polyethylene (PE), polypropylene (PP), both oriented and nonoriented, and copolymers thereof. Another example of a potentially suitable film for the facestock is a layer of microporous polyvinyl chloride (PVC) and copolymers thereof. Additional microporous materials include, but are not limited to, ortho-phthalaldehyde (OPA). For many applications, microporous PET is preferred. In addition, it may be preferred to utilize a biaxially oriented polypropylene (BOPP) microporous material. These materials provide cost savings as they are relatively inexpensive, and they have sufficient stiffness.

Since the outer face of the facestock will likely constitute the outermost surface of the label, in certain embodiments, the material selected for the facestock, at least along this outwardly directed face, preferably exhibits attractive printability characteristics.

Printability is typically defined by the sharpness and brightness of the image and by ink anchorage. The sharpness is closely related to the surface tension of the print surface. The ink anchorage is often tested by a tape test (Final test: FTM21). In general, PVC is printable with a variety of inks intended to be used with PVC. In most occasions the inks are water-based (especially in the US) or designed for UV drying (especially in Europe). In general, all polyolefin films can be printed with UV inks after on-press corona treatment, polyethylene being better than polypropylene mainly on ink adhesion. For waterbased inks an additional primer or topcoat is preferred to achieve good ink anchorage.

### Adhesive Layer

The various label assemblies include one or more adhesive layers. In one embodiment, the adhesive provides a tacky surface allowing a bond to another contacting surface. The adhesive layer may be a single adhesive layer or may be a multilayer adhesive.

A wide range of adhesives can be used in this layer so long as their properties and characteristics are consistent with the packaging and/or application requirements of the resulting label assembly. The adhesive could be a hot melt pressure sensitive adhesive, such as for example, a rubber-based or acrylic-based pressure sensitive adhesive. The adhesive could be a UV cured hot melt. The adhesive could be based on a rubber-based hot melt composition, a solvent rubber adhesive, a solvent acrylic adhesive, or a solvent polyurethane adhesive. The adhesive could be emulsion-based such as an emulsion acrylic adhesive. As noted, a wide array of adhesives could be used. Each of the aforementioned adhesives are preferably in the form of a pressure sensitive adhesive (PSA). An extensive selection of various pressure sensitive adhesives are disclosed in U.S. Pat. Nos. 5,623,011; 5,830,571; and 6,147,165; owned by the assignee of the present application.

The thickness of the pressure sensitive adhesive layer typically ranges from about 5 to about 40 microns and in certain embodiments from about 15 to about 22 microns. It will be understood however, that the present subject matter includes using thicknesses greater than or lesser than these thicknesses. The adhesive layer typically has a coat weight of from about 5 to about 50 g/m2, in certain embodiments from about 10 to about 30 g/m2, and in particular embodiments from about 15 to about 25 g/m2.

In the noted embodiments, the adhesive, e.g., the adhesive in layer 30, can be in a wide range of formulations. For example, the adhesive can comprise one or more acrylic components such as 2-ethylhexyl acrylate, butyl acrylate, and other acrylic and methacrylic esters. The adhesives can also be in the form of hot melt adhesives based upon block copolymers of styrene isoprene, styrene butadiene, and/or blends thereof. The adhesives can also be in the form of rubber based adhesives based upon styrene butadiene rubber (SBR), polyisobutylene and the like.

In particular embodiments, the adhesives exhibit a glass transition temperature (Tg), as measured via rheology, less than −10° C., more preferably less than −20° C., and most preferably less than −30° C. However, it will be appreciated that the present subject matter includes the use of adhesives exhibiting Tg's different than these representative value.

Regarding the adhesive used to adhere a label or label assembly to the outer surface of a blood bag, these are typically acrylic adhesives and may optionally include one or more tackifiers. In addition to or instead of acrylic adhesives, other adhesives may be used such as solvent adhesives, hot melt adhesives, and/or emulsion adhesives.

### Release Layer

In many of the embodiments described herein, the label assembly includes one or more of a release or liner layer. Preferably, the release layer is disposed immediately adjacent to the adhesive layer in the label. The release layer provides a release surface which is immediately adjacent to, and in contact with, the adhesive layer.

A wide variety of release materials such as those typically used for pressure sensitive tapes and labels are known, including silicones, alkyds, stearyl derivatives of vinyl polymers (such as polyvinyl stearyl carbamate), stearate chromic chloride, stearamides and the like. Fluorocarbon polymer coated release liners are also known but are relatively expensive. For most pressure sensitive adhesive applications, silicones are by far the most frequently used materials. Silicone release coatings have easy release at both high and low peel rates, making them suitable for a variety of production methods and applications.

Known silicone release coating systems generally include a reactive silicone polymer, e.g., an organopolysiloxane (often referred to as a “polysiloxane,” or simply, “siloxane”); a cross-linker; and a catalyst. After being applied to the adjacent layer or other substrate, the coating generally must be cured to cross-link the silicone polymer chains, either thermally or radiatively (by, e.g., ultraviolet or electron beam irradiation).

Based on the manner in which they are applied, three basic types of silicone release coatings used in the pressure sensitive adhesive industry are known: solvent borne, water borne emulsions, and solvent free coatings. Each type has advantages and disadvantages. Solvent borne silicone release coatings have been used extensively but, because they employ a hydrocarbon solvent, their use in recent years has tapered off due to increasingly strict air pollution regulations, high energy requirements, and high cost. Indeed, the energy requirements of solvent recovery or incineration generally exceed that of the coating operation itself.

Water borne silicone emulsion release systems are as well known as solvent systems, and have been used on a variety of pressure sensitive products, including tapes, floor tiles, and vinyl wall coverings. Their use has been limited, however, by problems associated with applying them to paper substrates. Water swells paper fibers, destroying the dimensional stability of the release liner backing and causing sheet curling and subsequent processing difficulties.

Solventless or solvent free silicone release coatings have grown in recent years and now represent a major segment of the silicone release coating market. Like other silicone coatings, they must be cured after being applied to the flexible liner substrate. Curing produces a cross-linked film that resists penetration by the pressure sensitive adhesive.

Informative descriptions of various release materials, their characteristics, and incorporation in laminate assemblies are provided in U.S. Pat. Nos. 5,728,469; 6,486,267; and US Published Patent Application 2005/0074549, owned by the assignee of the present application. It is also contemplated that various waxes known in the art could be used for the release material or utilized in the release layer.

In many embodiments, the labels utilize release layers that are relatively thin. For example, a typical release layer thickness is from about 0.2 to about 4 microns. Preferably, the thickness of the release layer is from about 0.5 to about 1.5 microns.

### EXAMPLES

In order to assess various aspects and features of the present subject matter, a pressure sensitive label construction with microporous polypropylene in accordance with the present subject matter was die cut in a size of 85 cm by 85 cm as well as 100 cm by 100 cm and the label samples were applied on blood bags.

As a comparative reference, a pressure sensitive construction with oriented nonporous polypropylene was die cut in the size of 85 cm by 85 cm as well as 100 cm by 100 cm and were applied on blood bags.

As a comparative reference, a pressure sensitive construction with cast nonporous polypropylene was die cut in a size of 85 cm by 85 cm as well as 100 cm by 100 cm and were applied on blood bags.

As a comparative reference, a pressure sensitive construction with WS Paper was die cut in the size of 85 cm by 85 cm as well as 100 cm by 100 cm and were applied on blood bags.

As a comparative reference, a dwell time of 15 minutes at room temperature was given to all samples. The blood bags were then sealed in a polypropylene bag as per blood bag industry standards and sterilization was carried out at 121° C. for 30 minutes to 45 minutes. The bags were then dried at 80° C. for 8 hours in an oven.

The bags were then filled with 100 ml water and centrifuged at 10 ° C. and 4 ° C. for 10 minutes each at 4000 rpm. The bags were then kept in deep freeze at −80° C. for 24 hours and were then thawed in a water bath for 30 minutes at 37° C.

TABLE 1
Comparative Study of Different Face Films for Blood Bag PSA Labels

| | | Cast PP | Oriented PP | |
|---|---|---|---|---|
| Parameters | Microporous PP | (nonporous) | (nonporous) | WS Paper |
| Sterilization 121° C.- | Label intact | Tunnel/piping | tunnel/piping | Label intact |
| 30 min | | | | |
| Oven 80° C.-8 hr | No shrinkage | Enhanced piping | Enhanced piping | No shrinkage |
| Centrifugation | Label intact | Edge-lift, piping | Edge-lift, piping | Edge tear/lift |
| | | worsens | worsens | |
| Deep Freeze | Label intact | Not tested as | Not tested as | No further damage |
| | | already failed | already failed | |
| Water bath | Water resistance | Not tested as | Not tested as | Water absorption |
| | | already failed | already failed | |

Table 1 shows that porosity in polypropylene or in paper makes it possible for the construction to withstand sterilization however oriented or cast polypropylene which has no porosity does not allow the entrapped air between the pliable PVC surface and the label thus causing the piping or tunnel effect on the label. Furthermore, paper shows issues after centrifugation and water bath tests.

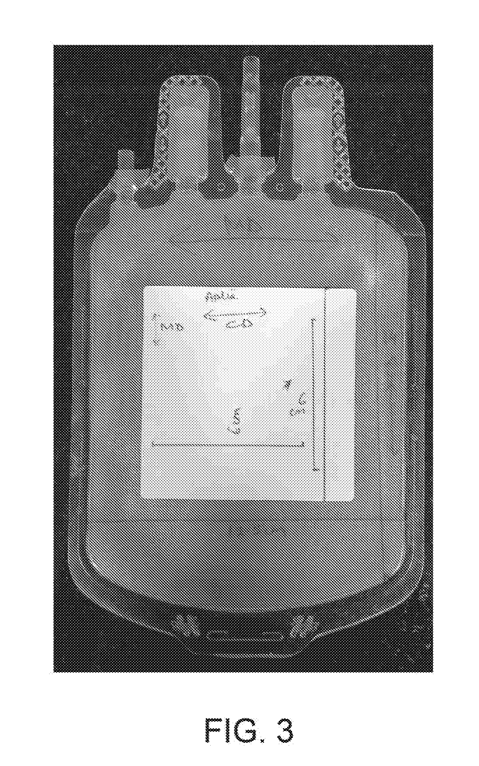

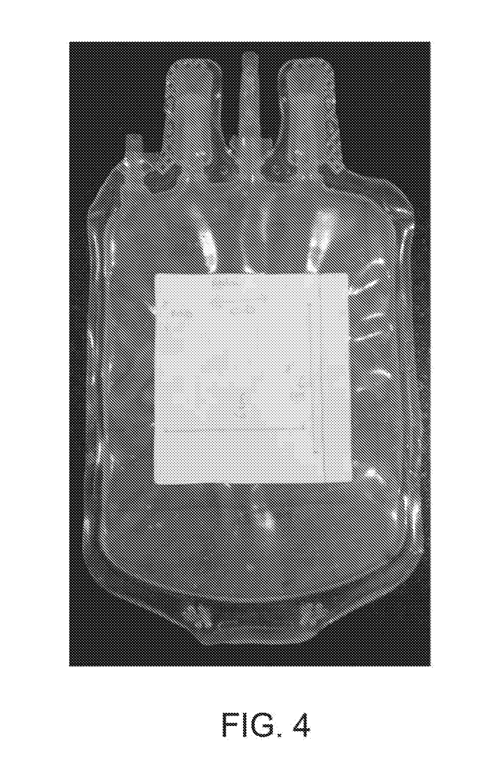

FIGS. 3 and 4 are photographs of a labelled blood bag in accordance with the present subject matter showing close matching between shrinkage and/or dimensional changes in the label and the blood bag occurring after sterilization, i.e., heating. FIG. 3 illustrates the labelled bag with dimensional markings showing dimensions in both a machine direction and a cross direction on both the label and the bag. FIG. 4 illustrates the labelled bag after sterilization and demonstrates that although shrinkage occurred, the extent of shrinkage of both the label and bag was similar in the machine direction and in the cross direction.

Microporosity improves adhesion and thus enables the label construction to further withstand centrifugation, maintaining the label integrity.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

The following embodiments are contemplated. All combinations of features and embodiments are contemplated.

Embodiment 1: a label adapted for use on blood bags, the label comprising a microporous polypropylene film defining a first face and an oppositely directed second face and an adhesive disposed on at least one of the first face and the second face of the film.

Embodiment 2: the embodiment of embodiment 1 wherein upon exposure to a temperature of 121° C. for 30 minutes, the label exhibits shrinkage characteristics that closely match shrinkage characteristics of the blood bag.

Embodiment 3: the embodiment of embodiments 1-2 wherein the polypropylene film has a density within a range of from 0.5 to 0.6 g/cc.

Embodiment 4: the embodiment of embodiments 1-3 wherein the polypropylene film has a thickness in a range of from 100 microns to 200 microns.

Embodiment 5: the embodiment of embodiments 1-4 wherein the polypropylene film exhibits a porosity within a range of from 2,500 to 4,771 Gurley seconds.

Embodiment 6: the embodiment of embodiments 1-5 wherein the polypropylene film exhibits shrinkage of less than 2% in a machine direction and 4-6% in a cross direction upon exposure to a temperature of 121° C. for 30 minutes.

Embodiment 7: the embodiment of embodiment s 1-6 further comprising an additional layer adjacent to either the microporous polypropylene film or the adhesive.

Embodiment 8: the embodiment of embodiments 1-7 further comprising a release layer at least partially covering the adhesive.

Embodiment 9: the embodiment of embodiments 1-8 wherein the adhesive is a solvent based pressure sensitive adhesive.

Embodiment 10: the embodiment of embodiments 1-9 wherein the adhesive is an acrylic adhesive.

Embodiment 11: the embodiment of embodiments 1-10 wherein the adhesive is a solvent based permanent acrylic pressure sensitive adhesive having a service temperature within a range of from −80° C. to 140° C.

Embodiment 12: a labelled blood bag comprising a blood bag defining an outer surface, and a label adhered to the outer surface of the blood bag, the label including a microporous polypropylene film defining an outer face and an inner face, and adhesive disposed between the inner face of the film and the outer surface of the blood bag.

Embodiment 13: the embodiment of embodiment 12 wherein upon exposure to a temperature of 121° C. for 30 minutes, the label exhibits shrinkage characteristics that closely match shrinkage characteristics of the blood bag.

Embodiment 14: the embodiment of embodiments 12-13 wherein the polypropylene film has a density within a range of from 0.5 to 0.6 g/cc.

Embodiment 15: the embodiment of embodiments 12-14 wherein the polypropylene film has a thickness in a range of from 100 microns to 200 microns.

Embodiment 16: the embodiment of embodiments 12-15 wherein the polypropylene film exhibits a porosity within a range of from 2,500 to 4,771 Gurley seconds.

Embodiment 17: the embodiment of embodiments 12-16 wherein the polypropylene film exhibits shrinkage of less than 2% in a machine direction and 4-6% in a cross direction upon exposure to a temperature of 121° C. for 30 minutes.

Embodiment 18: the embodiment of embodiments 12-17 wherein the label further includes an additional layer adjacent to either the microporous polypropylene film or the adhesive.

Embodiment 19: the embodiment of embodiments 12-18 wherein the adhesive is a solvent based pressure sensitive adhesive.

Embodiment 20: the embodiment of embodiments 12-19 wherein the adhesive is an acrylic adhesive.

Embodiment 21: the embodiment of embodiments 12-20 wherein the adhesive is a solvent based permanent acrylic pressure sensitive adhesive having a service temperature within a range of from −80° C. to 140° C.

Embodiment 22: a microporous polypropylene film wherein upon exposure to a temperature of 121° C. for 30 minutes, the label exhibits shrinkage characteristics that closely match shrinkage characteristics of a blood bag having a wall material of polyvinyl chloride.

Embodiment 23: the embodiment of embodiment 22 wherein the polypropylene film has a density within a range of from 0.5 to 0.6 g/cc.

Embodiment 24: the embodiment of embodiments 22-23 wherein the polypropylene film has a thickness in a range of from 100 microns to 200 microns.

Embodiment 25: the embodiment of embodiments 22-24 wherein the polypropylene film exhibits a porosity within a range of from 2,500 to 4,771 Gurley seconds.

Embodiment 26: the embodiment of embodiments 22-25 wherein the polypropylene film exhibits shrinkage of less than 2% in a machine direction and 4-6% in a cross direction upon exposure to a temperature of 121° C. for 30 minutes.

Embodiment 27: the embodiment of embodiments 22-26 wherein the film exhibits a porosity within a range of from 2,500 to 4,771 Gurley seconds.

Embodiment 28: the embodiment of embodiment 1, wherein upon exposure to sterilization conditions, the label exhibits shrinkage characteristics that closely match shrinkage characteristics of the blood bag.

Embodiment 29: the embodiment of embodiment 12, wherein upon exposure to sterilization conditions, the label exhibits shrinkage characteristics that closely match shrinkage characteristics of the blood bag.

Embodiment 30: A microporous polypropylene film wherein upon exposure to sterilization conditions, the film exhibits shrinkage characteristics that closely match shrinkage characteristics of a blood bag exposed to the sterilization conditions.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A label adapted for use on blood bags, the label comprising:
a microporous polypropylene film defining a first face and an oppositely directed second face;
adhesive disposed on at least one of the first face and the second face of the film.

2. The label of claim 1 wherein upon exposure to sterilization conditions, the label exhibits shrinkage characteristics that closely match shrinkage characteristics of the blood bag.

3. The label of claim 2 wherein upon exposure to a temperature of 121° C. for 30 minutes, the label exhibits shrinkage characteristics that closely match shrinkage characteristics of the blood bag and wherein the blood bag comprises polyvinyl chloride.

4. The label of claim 1 wherein the polypropylene film has a density within a range of from 0.5 to 0.6 g/cc.

5. The label of claim 1 wherein the polypropylene film has a thickness in a range of from 100 microns to 200 microns.

6. The label of claim 1 wherein the polypropylene film exhibits a porosity within a range of from 2,500 to 4,771 Gurley seconds.

7. The label of claim 1 wherein the polypropylene film exhibits shrinkage of less than 2% in a machine direction and 4-6% in a cross direction upon exposure to a temperature of 121° C. for 30 minutes.

8. The label of claim 1 further comprising:
an additional layer adjacent to either the microporous polypropylene film or the adhesive.

9. The label of claim 1 further comprising:
a release layer at least partially covering the adhesive.

10. The label of claim 1 wherein the adhesive is a solvent based pressure sensitive adhesive.

11. The label of claim 1 wherein the adhesive is an acrylic adhesive.

12. The label of claim 1 wherein the adhesive is a solvent based permanent acrylic pressure sensitive adhesive having a service temperature within a range of from −80° C. to 140° C.

13. A labelled blood bag comprising:
a blood bag defining an outer surface; and
a label adhered to the outer surface of the blood bag, the label including a microporous polypropylene film defining an outer face and an inner face, and adhesive disposed between the inner face of the film and the outer surface of the blood bag.

14. The labelled blood bag of claim 13 wherein upon exposure to sterilization conditions, the label exhibits shrinkage characteristics that closely match shrinkage characteristics of the blood bag.

15. The labelled blood bag of claim 13 wherein upon exposure to a temperature of 121° C. for 30 minutes, the label exhibits shrinkage characteristics that closely match shrinkage characteristics of the blood bag and wherein the blood bag comprises polyvinyl chloride.

16. The labelled blood bag of claim 13 wherein the polypropylene film has a density within a range of from 0.5 to 0.6 g/cc.

17. The labelled blood bag of claim 13 wherein the polypropylene film has a thickness in a range of from 100 microns to 200 microns.

18. The labelled blood bag of claim 13 wherein the polypropylene film exhibits a porosity within a range of from 2,500 to 4,771 Gurley seconds.

19. The labelled blood bag of claim 13 wherein the polypropylene film exhibits shrinkage of less than 2% in a machine direction and 4-6% in a cross direction upon exposure to a temperature of 121° C. for 30 minutes.

20. The labelled blood bag of claim 13 wherein the label further includes an additional layer adjacent to either the microporous polypropylene film or the adhesive.

21. The labelled blood bag of claim 13 wherein the adhesive is a solvent based pressure sensitive adhesive.

22. The labelled blood bag of claim 13 wherein the adhesive is an acrylic adhesive.

23. The labelled blood bag of claim 13 wherein the adhesive is a solvent based permanent acrylic pressure sensitive adhesive having a service temperature within a range of from −80° C. to 140° C.

24. A microporous polypropylene film wherein upon exposure to sterilization conditions, the film exhibits shrinkage characteristics that closely match shrinkage characteristics of a blood bag exposed to the sterilization conditions.

25. The film wherein of claim 24, wherein the blood bag has a wall material of polyvinyl chloride, and wherein upon exposure to a temperature of 121° C. for 30 minutes, the film exhibits shrinkage characteristics that closely match shrinkage characteristics of the blood bag.

26. The film of claim 24 wherein the polypropylene film has a density within a range of from 0.5 to 0.6 g/cc.

27. The film of claim 24 wherein the polypropylene film has a thickness in a range of from 100 microns to 200 microns.

28. The film of claim 24 wherein the polypropylene film exhibits a porosity within a range of from 2,500 to 4,771 Gurley seconds.

29. The film of claim 24 wherein the polypropylene film exhibits shrinkage of less than 2% in a machine direction and 4-6% in a cross direction upon exposure to a temperature of 121° C. for 30 minutes.

30. The film of claim 24 wherein the film exhibits a porosity within a range of from 2,500 to 4,771 Gurley seconds.
